(19) United States
(12) Patent Application Publication
(10) Pub. No.: US 2023/0358243 A1
(43) Pub. Date: Nov. 9, 2023

(54) MOTOR, FAN, AND AIR CONDITIONER

(71) Applicant: Mitsubishi Electric Corporation, Tokyo (JP)

(72) Inventors: Ryogo TAKAHASHI, Tokyo (JP); Hiroki ASO, Tokyo (JP); Takaya SHIMOKAWA, Tokyo (JP); Takanori WATANABE, Tokyo (JP); Kazuchika TSUCHIDA, Tokyo (JP)

(21) Appl. No.: 18/245,648

(22) PCT Filed: Oct. 14, 2020
(86) PCT No.: PCT/JP2020/038795

§ 371 Date: Mar. 16, 2023

(51) Int. Cl. F04D 25/06; H02K 5/22

(52) U.S. Cl. CPC F04D 25/0693; H02K 5/225; F24F 1/38

(57) ABSTRACT

A motor includes a rotor, a stator surrounding the rotor, a circuit board attached to the stator, a mold resin part covering the stator and the circuit board, a lead wire connected to the circuit board and drawn out of the mold resin part, and a cover member provided on the mold resin part and made of a resin. The cover portion and an outer circumferential surface of the mold resin part form a housing space in which the lead wire is housed. The cover portion has a hole portion through which the lead wire is drawn out of the housing space.

### CROSS-REFERENCE TO RELATED APPLICATION

This application is a U.S. National Stage Application of International Application No. PCT/JP2020/038795 filed on Oct. 14, 2020, the contents of which are incorporated herein by reference.

### TECHNICAL FIELD

The present disclosure relates to a motor, a fan, and an air conditioner.

### BACKGROUND

Conventionally, there is known a motor including a rotor, a stator, and a circuit board which are covered with a mold resin part. A lead wire is connected to the circuit board and drawn out of the mold resin part to the outside (see, for example, Patent Reference 1).

### PATENT REFERENCE

Patent Reference 1: Japanese Patent Application Publication No. 3-118743 (FIG. 1)

However, if water, especially, water vapor enters the motor through a portion through which the lead wire is drawn out of the mold resin part, it may cause malfunction of the motor.

### SUMMARY

The present disclosure is intended to solve the above-described problem, and an object of the present disclosure is to suppress the entry of water into a motor.

A motor of the present disclosure includes a rotor, a stator surrounding the rotor, a circuit board attached to the stator, a mold resin part covering the stator and the circuit board, a lead wire connected to the circuit board and drawn out of the mold resin part, and a cover member provided on the mold resin part and made of a resin. The cover member and an outer circumferential surface of the mold resin part form a housing space in which the lead wire is housed. The cover member has a hole portion through which the lead wire is drawn out of the housing space. The cover member has a curved surface facing the mold resin part. A curvature radius r of the curved surface is smaller than or equal to a curvature radius R of the outer circumferential surface of the mold resin part.

In the present disclosure, the lead wire drawn out of the mold resin part is housed in the housing space formed by the cover member and the outer circumferential surface of the mold resin part, and thus it is possible to suppress the entry of water into the motor.

### BRIEF DESCRIPTION OF DRAWINGS

FIG. 1 is a perspective view illustrating a motor of a first embodiment.

FIG. 2 is a sectional view illustrating the motor of the first embodiment.

FIG. 3 is a plan view illustrating a state in which a circuit board is attached to a stator of the first embodiment.

FIG. 4 is a diagram of the motor of the first embodiment as viewed from the counter-load side.

FIG. 5 is a cutout perspective view illustrating a cover member, an outlet portion, and lead wires of the first embodiment.

FIG. 6 is a side view illustrating the motor of the first embodiment.

FIG. 7 is a sectional view illustrating the cover member, the outlet portion, and the lead wires of the first embodiment.

FIGS. 8(A) and 8(B) are schematic diagrams for explaining the relationship between an end surface of the cover member and an outer circumferential surface of the mold resin part of the first embodiment.

FIG. 9 is a cutout perspective view illustrating a cover member, an outlet portion, and lead wires of a second embodiment.

FIG. 10 is a side view illustrating a motor of the second embodiment.

FIG. 11 is a sectional view illustrating the cover member, the outlet portion, and the lead wires of the second embodiment.

FIG. 12 is a sectional view illustrating a cover member, an outlet portion, and lead wires of a third embodiment.

FIG. 13 is a side view illustrating a motor of a fourth embodiment.

FIG. 14(A) is a side view illustrating a motor of a fifth embodiment, and FIG. 14(B) is a perspective view illustrating a fastening member.

FIG. 15 is a side view illustrating a motor of another configuration example of the fifth embodiment.

FIG. 16 is a side view illustrating a motor of still another configuration example of the fifth embodiment.

FIG. 17 is a sectional view illustrating a cover member, an outlet portion, and lead wires of a sixth embodiment.

FIG. 18 is a sectional view illustrating a cover member, an outlet portion, and lead wires of a seventh embodiment.

FIG. 19 is a sectional view illustrating a state in which a cover member of an eighth embodiment is divided.

FIG. 20 is a sectional view illustrating the cover member, an outlet portion, and lead wires of the eighth embodiment.

FIG. 21 is a sectional view illustrating a cover member of a modification of the eighth embodiment.

FIG. 22(A) is a diagram illustrating an air conditioner to which the motor of each embodiment or modification is applicable, and FIG. 22(B) is a diagram illustrating an outdoor unit to which the motor of each embodiment or modification is applicable.

### DETAILED DESCRIPTION

### First Embodiment

### (Configuration of Motor 1)

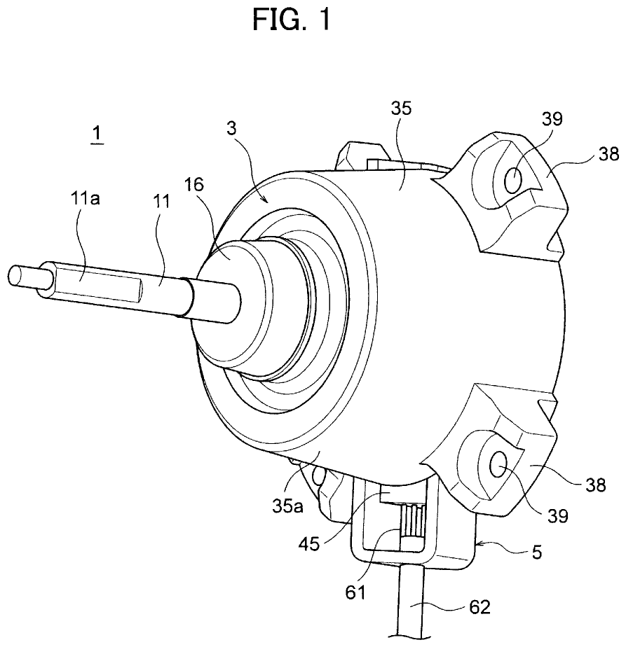

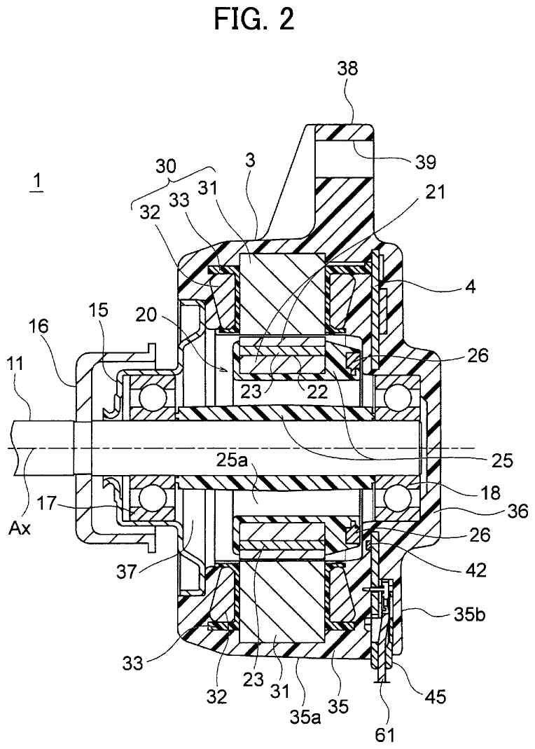

FIG. 1 is a perspective view illustrating a motor 1 of a first embodiment. FIG. 2 is a sectional view illustrating the motor 1 of the first embodiment. As illustrated in FIG. 2, the motor 1 includes a rotor 20, a stator 30 provided to surround the rotor 20, a circuit board 4 attached to the stator 30, a mold resin part 35 covering the stator 30 and the circuit board 4.

The rotor 20 has a shaft 11. The rotation axis of the rotor 20, i.e., the central axis of the shaft 11, is a center axis Ax. The stator 30 and the circuit board 4 are covered with the mold resin part 35 to constitute a mold stator 3.

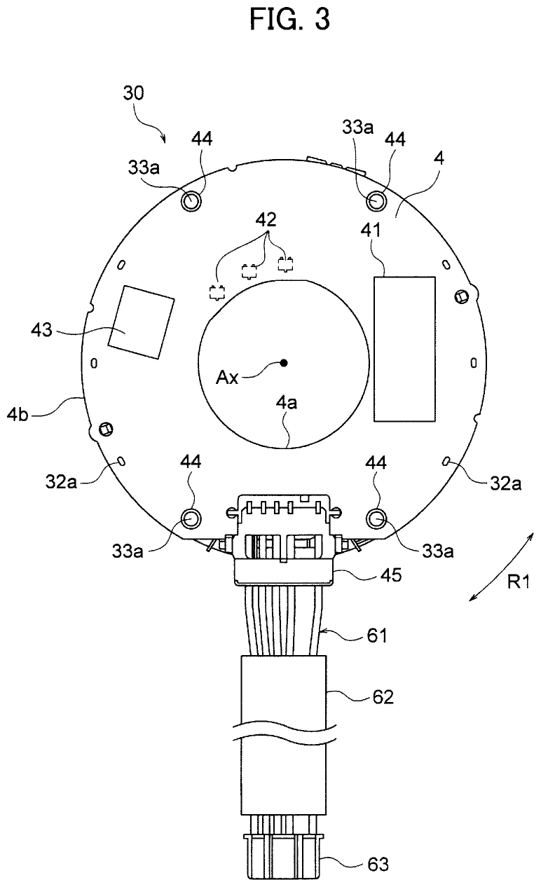

In the description below, the direction of the center axis Ax is referred to as an “axial direction”. The circumferential direction about the center axis Ax is referred to as a “circumferential direction”, and indicated by the arrow R1 in FIG. 3 and other figures. The radial direction about the center axis Ax is referred to as a “radial direction”.

The shaft 11 protrudes from the stator 30 to the left side in FIG. 2, and, for example, an impeller of a blowing fan is attached to the protruding portion of the shaft 11. Thus, the protruding side (the left side in FIG. 2) of the shaft 11 is referred to as a “load side”, while its opposite side (the right side in FIG. 2) is referred to as a “counter-load side”.

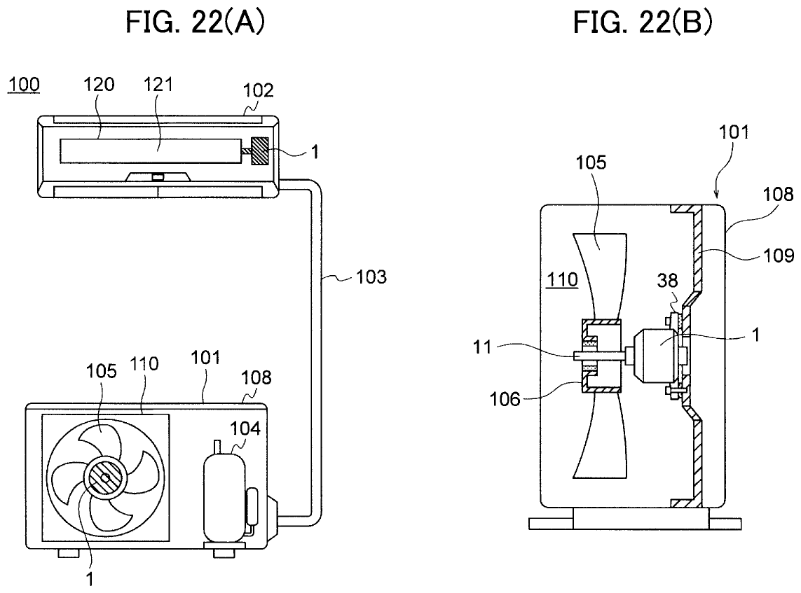

The motor 1 is mounted on a mounting portion such as a frame 109 (FIG. 22(B)) of an outdoor unit 101 of an air conditioner 100, for example. The center axis Ax is desirably horizontal in a state where the motor 1 is mounted on the mounting portion.

### (Configuration of Rotor 20)

The rotor 20 has the above-described shaft 11, an annular rotor core 21 surrounding the shaft 11, a plurality of rotor magnets (permanent magnets) 23 attached to the rotor core 21, and a resin portion 25 supporting the rotor core 21.

The rotor core 21 is formed of a stacking body in which a plurality of electromagnetic steel sheets are stacked in the axial direction and fastened together by crimping or the like. The rotor core 21 has a plurality of magnet insertion holes 22 in the circumferential direction. The rotor magnets 23 are inserted in the magnet insertion holes 22. The rotor magnet 23 is, for example, a rare earth magnet that contains neodymium (Nd), iron (Fe) and boron (B).

The rotor 20 is a normal pole rotor in which all the magnetic poles are formed of the rotor magnets 23. However, the rotor 20 may be a consequent pole rotor that includes magnet magnetic poles formed by rotor magnets 23 and virtual magnetic poles formed by parts of the rotor core 21.

The resin portion 25 is provided to cover the shaft 11 and supports the rotor core 21. The resin portion 25 is made of a thermoplastic resin such as polybutylene terephthalate (PBT). The resin portion 25 may be provided with cavities 25a. An annular sensor magnet 26 is attached on the counter-load side of the rotor 20 and held by the resin portion 25.

### (Configuration of Stator 30)

The stator 30 is disposed on the outer side of the rotor 20 in the radial direction and surrounds the rotor 20. The stator 30 includes an annular stator core 31, an insulator 33 attached to the stator core 31, and coils 32 wound on the stator core 31 via the insulator 33. The stator core 31 is formed of a stacking body in which a plurality of electromagnetic steel sheets are stacked in the axial direction and fastened together by crimping or the like.

The insulator 33 insulates the stator core 31 from the coils 32 and is formed of a thermoplastic resin such as PBT. The insulator 33 has an inner wall and an outer wall which support the coils 32 from both sides in the radial direction. A plurality of protrusions 33a (FIG. 3) for fixing the circuit board 4 are arranged on the outer wall of the insulator 33. The protrusions 33a are engaged with attachment holes 44 (FIG. 3) formed on the circuit board 4.

The coils 32 are formed, for example, by winding magnet wires on the stator core 31. The coils 32 are three-phase windings, which are formed of U-phase, V-phase, and W-phase coils. The coils 32 are connected to terminals 32a (FIG. 3), which are disposed on the outer wall of the insulator 33, by fusing (thermal caulking), soldering, or the like.

A mold resin part 35 covers the outer circumference and the counter-load side of the stator 30. The mold resin part 35 also covers the circuit board 4 attached to the stator 30. The mold resin part 35 is formed of, for example, a thermosetting resin such as a bulk molding compound (BMC).

The mold resin part 35 includes a bearing support portion 36 on the counter-load side and an opening 37 on the load side. The rotor 20 is inserted into inside the stator 30 through the opening 37. A metal bracket 15 is attached to the opening 37 of the mold resin part 35.

Of bearings 17 and 18 supporting the shaft 11, one bearing 17 is held by the bracket 15, and the other bearing 18 is held by the bearing support portion 36. A cap 16 for preventing the entry of water or the like into the bearing 17 is attached to the shaft 11.

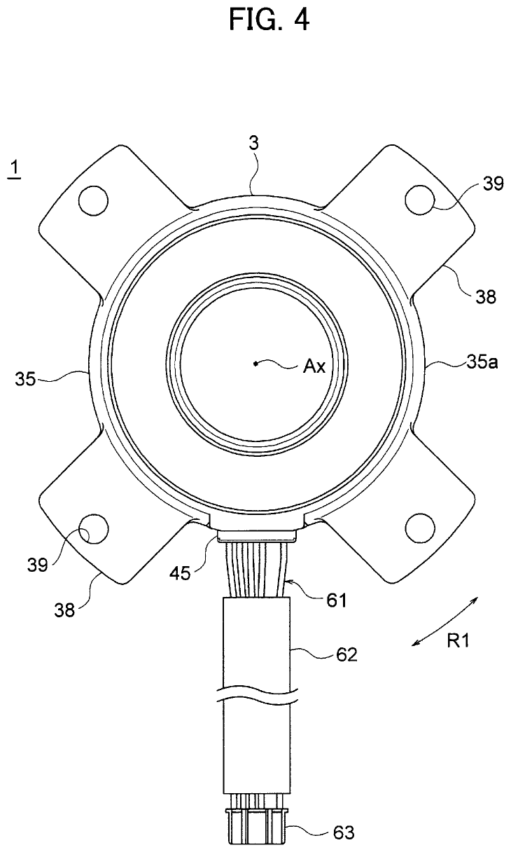

The mold resin part 35 has legs 38 extending outward in the radial direction from its outer circumferential surface 35a. The legs 38 are portions at which the motor 1 is mounted on the mounting portion. Each leg 38 has an attachment hole 39 through which a fixing tool, such as a screw, is inserted. The mounting portion is, for example, a frame 109 (FIG. 22(B)) of the outdoor unit 101. Four legs 38 are provided in this example (see FIG. 4), but the number of legs 38 is not limited to four.

### (Configuration of Circuit Board 4)

The circuit board 4 is disposed on one side in the axial direction with respect to the stator 30. The circuit board 4 is disposed on the counter-load side (the right side in FIG. 2) of the stator 30 in this example, but may be disposed on the load side (the left side in FIG. 2) of the stator 30.

FIG. 3 is a plan view illustrating a state in which the circuit board 4 is attached to the stator 30. The circuit board 4 is, for example, a printed circuit board. The printed circuit board includes a plate-shaped base having an insulating property on which a wiring pattern made of a conductor is formed. The printed circuit board may be provided with a through hole as needed.

The circuit board 4 has an annular shape about the center axis Ax. The circuit board 4 has an inner circumferential edge 4a, which is an end edge on the inner side in the radial direction, and an outer circumferential edge 4b, which is an end edge on the outer side in the radial direction. A plurality of attachment holes 44 are formed along the outer circumferential edge 4b of the circuit board 4. The attachment holes 44 engage with the above-described protrusions 33a.

Elements associated with the control of the motor 1 are mounted on the circuit board 4. In this example, a drive circuit 41, Hall elements 42, and a microcomputer 43 are mounted on the circuit board 4. The drive circuit 41 is constituted by a power transistor and controls the rotation of the rotor 20. The Hall elements 42 detect magnetic flux from the sensor magnet 26. The microcomputer 43 detects a rotary position of the rotor 20 based on the detected signal of the Hall elements 42 and outputs a signal to the drive circuit 41.

Lead wires 61 are wired on the circuit board 4. The lead wires 61 include power supply lead wires for supplying power to the coils 32 of the stator 30 and sensor lead wires for transmitting the detection signal of the Hall elements 42 to the outside.

An outlet portion 45 for drawing out the lead wires 61 to the outside of the motor 1 is attached to the outer circumferential edge 4b of the circuit board 4. The outlet portion 45 is made of, for example, a thermoplastic resin such as PBT. The outlet portion 45 is provided by insert molding so that part of the outlet portion 45 is exposed from the mold resin part 35.

FIG. 4 is a diagram of the motor 1 as viewed from the counter-load side. Apart of the outlet portion 45 is exposed from the outer circumferential surface 35a of the mold resin part 35. The lead wires 61 are drawn out of the mold resin part 35 outward in the radial direction about the center axis Ax. That is, the drawing direction of the lead wires 61 is the radial direction about the center axis Ax.

The lead wires 61 are bundled and covered by a resin tube 62 outside the mold resin part 35. A terminal 63 connected to a controller outside the motor 1 is attached to the ends of the lead wires 61 opposite to the outlet portion 45.

During manufacturing of the mold stator 3, the lead wires 61 are assembled to the circuit board 4 on which the drive circuit 41 and the like are mounted. Thereafter, protrusions 33a of the stator 30 are inserted through the attachment holes 44 of the circuit board 4 (FIG. 3), and the tips of the protrusions 33a are welded thermally or ultrasonically, thereby fixing the circuit board 4 to the stator 30. Then, the stator 30 and the circuit board 4 are integrally formed with a resin such as BMC. In this way, the mold stator 3 in which the stator 30 and the circuit board 4 are covered with the mold resin part 35 is obtained.

### (Cover Member 5)

As illustrated in FIG. 1, a resin cover member 5 is attached to the outer circumferential surface 35a of the mold resin part 35 so as to cover the lead wires 61 drawn out of the mold resin part 35. The cover member 5 is made of, for example, PBT or ABS (acrylonitrile butadiene styrene) resin or the like. In this regard, the cover member 5 is omitted in FIGS. 2 to 4.

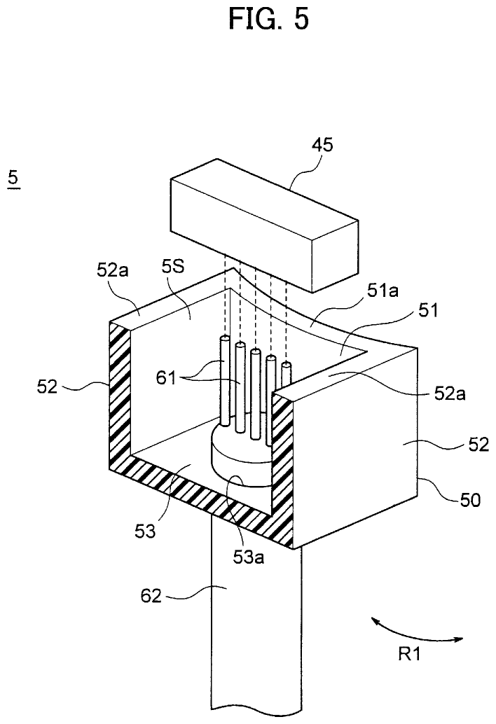

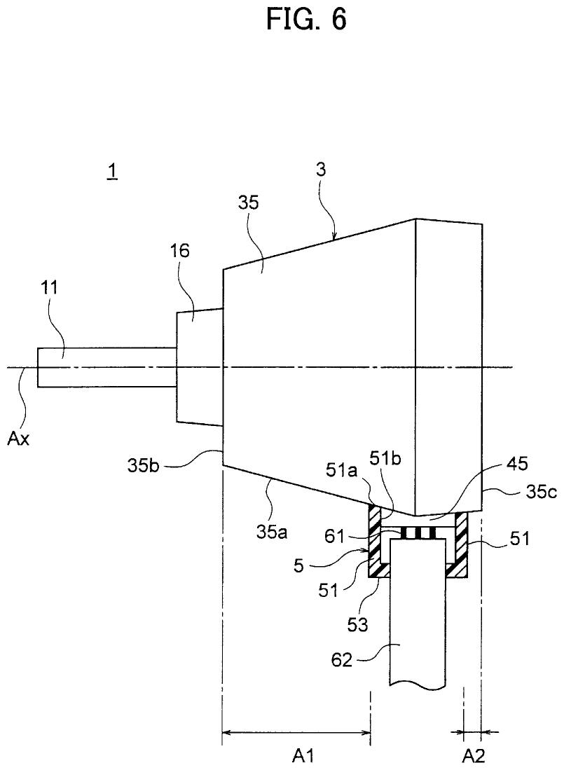

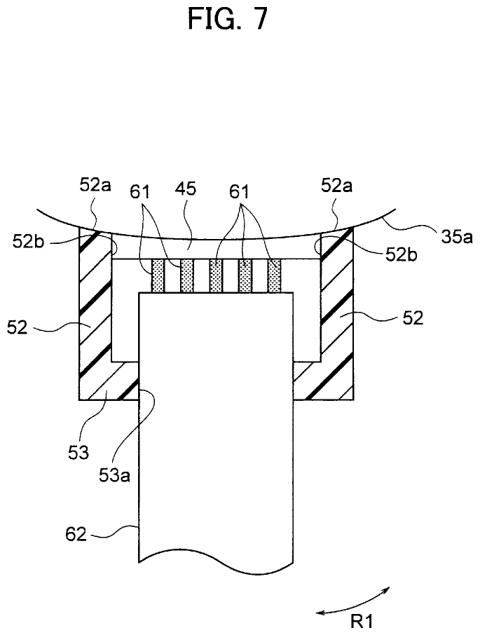

FIG. 5 is a cutout perspective view illustrating the cover member 5, the outlet portion 45, and the lead wires 61. FIG. 6 is a side view of the motor 1, illustrating the cover member 5 cut out in a plane parallel to the center axis Ax. FIG. 7 is a sectional view in a plane orthogonal to the center axis Ax, illustrating the cover member 5, the outlet portion 45, and the lead wires 61.

As illustrated in FIG. 5, the cover member 5 has a box shape that has an opening 5S on the mold resin part 35 side. More specifically, the cover member 5 has a pair of first wall portions 51 (FIG. 6) facing each other in the axial direction, a pair of second wall portions 52 facing each other in the circumferential direction, and a bottom portion 53 located on the opposite side to the opening 5S. The wall portions 51 and 52 and the bottom portion 53 constitute a casing part 50.

The opening 5S of the cover member 5 is closed by the outer circumferential surface 35a of the mold resin part 35. The bottom portion 53 is provided with a hole portion 53a through which the tube 62 passes. With the outer circumferential surface 35a of the mold resin part 35, the wall portions 51 and 52 and the bottom portion 53 form a housing space in which the lead wires 61 are housed.

As illustrated in FIG. 6, inner surfaces 51b of the pair of first wall portions 51 are desirably fitted to both sides of the outlet portion 45 in the axial direction. As illustrated in FIG. 7, inner surfaces 52b of the pair of second wall portions 52 are desirably fitted to both sides of the outlet portion 45 in the circumferential direction.

That is, the wall portions 51 and 52 of the cover member 5 are desirably fitted to the outlet portion 45. With this configuration, the cover member 5 can be positioned with respect to the mold resin part 35. By fitting the cover member 5 to the outlet portion 45, the cover member 5 can be attached to the mold resin part 35 without using adhesive agent.

The hole portion 53a at the bottom portion 53 of the cover member 5 is a hole through which the tube 62 passes. The cross-sectional shape of the hole portion 53a is the shape corresponding to the outer circumference of the tube 62, for example, a circle. The inner circumferential surface of the hole portion 53a is desirably in tight contact with the outer circumferential surface of the tube 62.

As illustrated in FIG. 5, the first wall portion 51 has an end surface 51a facing the mold resin part 35. The end surface 51a has the shape along the outer circumferential surface 35a of the mold resin part 35. The second wall portion 52 has an end surface 52a facing the mold resin part 35. The end surface 52a has the shape along the outer circumferential surface 35a of the mold resin part 35.

The sealing property of the housing space enclosed by the outer circumferential surface 35a of the mold resin part 35 and the cover member 5 can be enhanced by bringing the end surfaces 51a and 52a of the wall portions 51 and 52 into tight contact with the outer circumferential surface 35a of the mold resin part 35.

A resin forming the cover member 5 desirably has a lower modulus of elasticity than a resin forming the mold resin part 35. In other words, the cover member 5 is desirably more likely to be deformed elastically than the mold resin part 35. This relationship is satisfied when the cover member 5 is made of PBT or ABS while the mold resin part 35 is made of BMC.

In this case, when the cover member 5 is pressed against the outer circumferential surface 35a of the mold resin part 35, the cover member 5 is elastically deformed along the outer circumferential surface 35a of the mold resin part 35, and thus the adhesiveness between the cover member 5 and the outer circumferential surface 35a of the mold resin part 35 can be enhanced.

### (Action)

In a general motor having lead wires drawn out of a mold resin part, water, especially, water vapor with minute molecules may enter the motor through a portion through which the lead wires are drawn out. If water vapor entering the motor reaches the circuit board, it may cause malfunction of the motor. Hereinafter, the term “water” includes water vapor.

In the first embodiment, the lead wires 61 drawn out of the mold resin part 35 are housed in the housing space formed by the outer circumferential surface 35a of the mold resin part 35 and the cover member 5. The outlet portion 45 exposed from the mold resin part 35 is surrounded by the cover member 5. Thus, an entry route of the water into the motor 1 is blocked, and thus the malfunction of the motor 1 can be prevented.

As described above, the motor 1 is mounted on the mounting portion, such as the frame 109 (FIG. 22(B)) of the outdoor unit 101, with screws inserted through the attachment holes 39 of the legs 38. Desirably, the lead wires 61 are drawn downward out of the mold resin part 35 in the state where the motor 1 is mounted on the mounting portion, and the outlet portion 45 and the cover member 5 are located under the mold resin part 35.

If the lead wires 61 are drawn upward out of the mold resin part 35 while the outlet portion 45 and the cover member 5 are located above the mold resin part 35, the hole portion 53a of the cover member 5 is directed upward. Thus, water may enter the cover member 5 through a gap between the hole portion 53a and the tube 62.

In contrast, when the lead wires 61 are drawn downward out of the mold resin part 35 while the outlet portion 45 and the cover member 5 are located under the mold resin part 35, the hole portion 53a at the bottom portion 53 of the cover member 5 is directed downward. Thus, water is less likely to enter the cover member 5 through the gap between the hole portion 53a and the tube 62. Thus, the entry of water into the motor 1 can be suppressed more effectively.

As illustrated in FIG. 6, the cover member 5 is located on the inner side by a distance A1 from an end surface 35b of the mold resin part 35 on the load side and also located on the inner side by a distance A2 from an end surface 35c of the mold resin part 35 on the counter-load side in the axial direction. That is, the cover member 5 is located on the inner side in the axial direction with respect to both end surfaces 35b and 35c of the mold resin part 35 in the axial direction.

If the cover member 5 protrudes from the mold resin part 35 in the axial direction, water may enter the cover member 5 through its surface on the mold resin part 35 side. On the other hand, if the cover member 5 is located on the inner side in the axial direction with respect to both end surfaces 35b and 35c of the mold resin part 35 in the axial direction, the mold resin part 35 side of the cover member 5 is covered with the outer circumferential surface 35a of the mold resin part 35, and thus the entry of water into the cover member 5 can be suppressed.

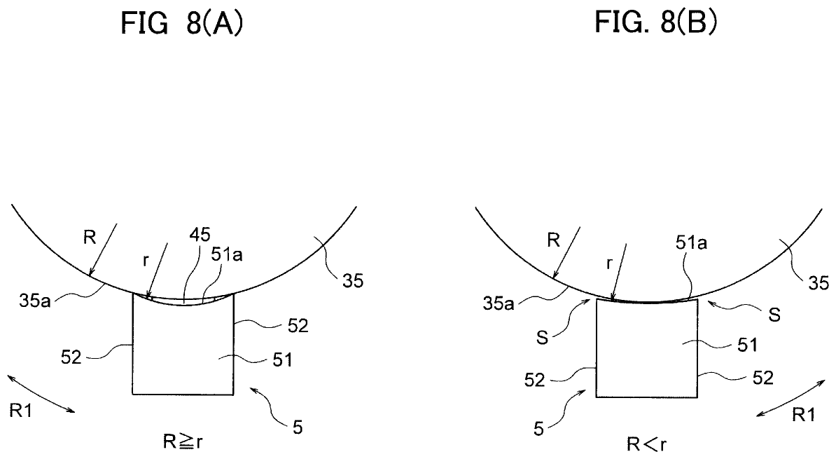

FIG. 8(A) is a schematic diagram illustrating the relationship between the end surface 51a of the first wall portion 51 and the outer circumferential surface 35a of the mold resin part 35 in the first embodiment. FIG. 8(B) is a schematic diagram illustrating the relationship between the end surface 51a of the first wall portions 51 and the outer circumferential surface 35a of the mold resin part 35 in another configuration example. The outer circumferential surface 35a of the mold resin part 35 has a circular shape in a section orthogonal to the center axis Ax.

The end surface 51a of the first wall portion 51 is formed in an arc shape which is convex facing the mold resin part 35. The curvature radius r of the end surface 51a is desirably smaller than or equal to the curvature radius R of the outer circumferential surface 35a of the mold resin part 35 (r R).

If the curvature radius r of the end surface 51a of the first wall portion 51 is larger than the curvature radius R of the outer circumferential surface 35a of the mold resin part 35 (r>R), a gap S is created between the outer circumferential surface 35a of the mold resin part 35 and the end surface 51a on both sides of the end surface 51a in the circumferential direction as in the configuration example illustrated in FIG. 8(B).

In contrast, if the curvature radius r of the end surface 51a of the first wall portion 51 is smaller than or equal to the curvature radius R of the outer circumferential surface 35a of the mold resin part 35 (r≤R), no gap S is created on each side of the end surface 51a in the circumferential direction as illustrated in FIG. 8(A). In this case, even if a gap is created at the center of the end surface 51a in the circumferential direction, this gap can be closed by the outlet portion 45. It is also possible to close the gap by a sealing agent.

The shape of the cover member 5 is not limited to the box shape illustrated in FIGS. 1, 5 and 6, but the cover member 5 may have any shape as long as a housing space for the lead wires 61 is formed between the cover member 5 and the outer circumferential surface 35a of the mold resin part 35. For example, the cover member 5 may have a cylindrical shape that has an opening on the mold resin part 35 side. Also in this case, the opening is closed by the outer circumferential surface 35a of the mold resin part 35, and the hole portion through which the lead wires 61 are drawn out is provided at the bottom portion of the cover member 5.

### Effects of Embodiment

As described above, in the first embodiment, the cover member 5 made of a resin is attached to the mold resin part 35 that covers the stator 30 and the circuit board 4, and the lead wires 61 drawn out of the mold resin part 35 are housed in the housing space formed by the cover member 5 and the outer circumferential surface 35a of the mold resin part 35. The cover member 5 has the hole portion 53a through which the lead wires 61 are drawn out of the housing space.

Since the lead wires 61 drawn out of the mold resin member 35 are housed in the housing space enclosed by the cover member 5 and the outer circumferential surface 35a of the mold resin part 35 as above, it is possible to block an entry route for water into the motor 1 and to suppress the entry of water into the motor 1. Thus, the malfunction of the motor 1 can be prevented.

The cover member 5 has the end surface 51a in an arc shape facing the outer circumferential surface 35a of the mold resin part 35. The curvature radius r of the end surface 51a is smaller than or equal to the curvature radius R of the outer circumferential surface 35a of the mold resin part 35 (r R). Consequently, it is possible to eliminate a gap on both sides of the cover member 5 in the circumferential direction. Thus, the entry of water into the motor 1 can be suppressed.

The cover member 5 is located on the inner side in the axial direction with respect to both end surfaces 35b and 35c of the mold resin part 35 in the axial direction. Thus, the opening of the cover member 5 is sufficiently closed by the outer circumferential surface 35a of the mold resin part 35, so that the entry of water into the motor 1 can be suppressed effectively.

Since the cover member 5 is made of a resin with a lower modulus of elasticity than a resin forming the mold resin part 35, the adhesiveness can be enhanced by pressing the cover member 5 against the outer circumferential surface 35a of the mold resin part 35, and thus the entry of water into the motor 1 can be effectively suppressed.

Since the cover member 5 is fitted to the outlet portion 45, the cover member 5 can be positioned with respect to the mold resin part 35. The gap between the cover member 5 and the mold resin part 35 is prevented from expanding due to displacement of the cover member 5, and thus the entry of water into the motor 1 can be suppressed effectively.

Since the cover member 5 is located under the mold resin part 35 in the state where the motor 1 is mounted on the mounting portion, water is less likely to enter the cover member 5 through the hole portion 53a, as compared to a case where the cover member 5 is located above the mold resin part 35. Thus, the entry of water into the motor 1 can be suppressed effectively.

### Second Embodiment

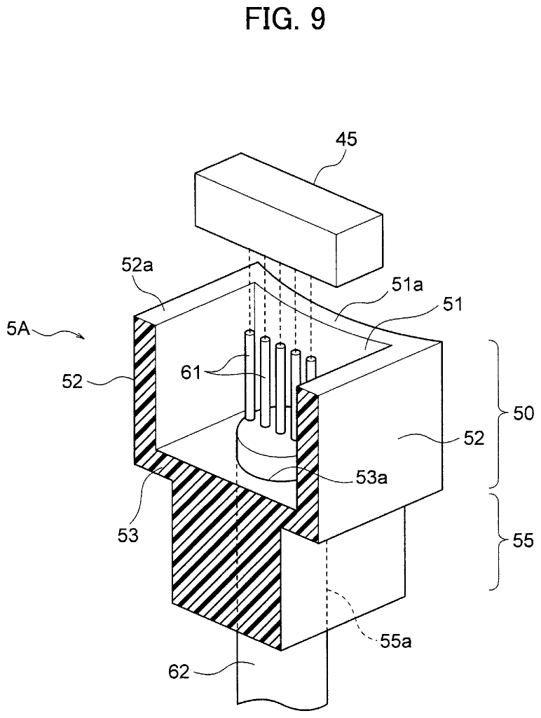

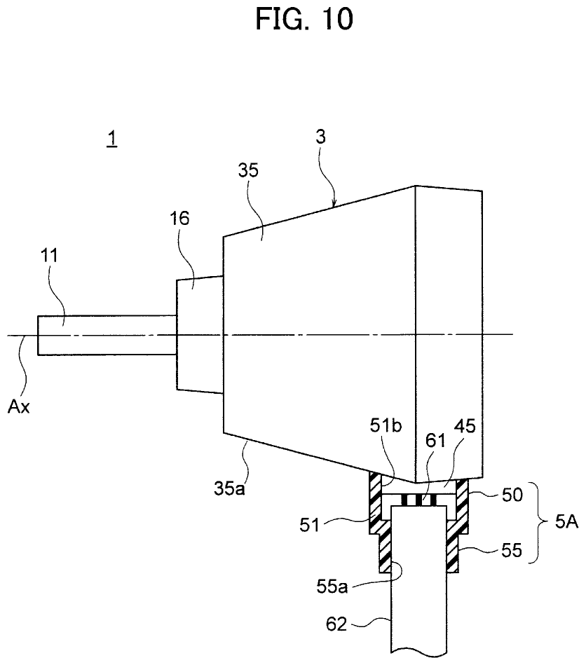

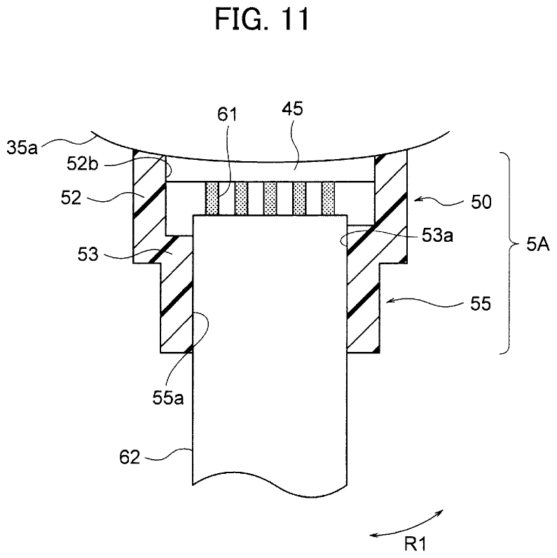

Next, a second embodiment will be described. FIG. 9 is a cutout perspective view illustrating a cover member 5A, the outlet portion 45 and the lead wires 61 of the second embodiment. FIG. 10 is a side view of the motor 1, illustrating the cover member 5A cut out in a plane parallel to the center axis Ax. FIG. 11 is a sectional view in a plane orthogonal to the center axis Ax, illustrating the cover member 5A, the outlet portion 45, and the lead wires 61.

The cover member 5A of the second embodiment has a tube enclosing part 55 that encloses the tube 62, in addition to the casing part 50 described in the first embodiment. That is, the cover member 5A has a two-stage structure including the casing part 50 and the tube enclosing part 55. The casing part 50 and the tube enclosing part 55 are integrally formed of the same material.

The tube enclosing part 55 is provided on the side opposite to the mold resin part 35 with respect to the casing part 50. The tube enclosing part 55 extends in the drawing direction of the lead wires 61, i.e., in the radial direction about the center axis Ax. The tube enclosing part 55 desirably extends downward from the bottom portion 53 in a state where the motor 1 is mounted on the mounting portion.

As illustrated in FIGS. 10 and 11, the tube enclosing part 55 has a hole portion 55a through which the tube 62 passes. The hole portion 55a of the tube enclosing part 55 encloses the tube 62 drawn out of the hole portion 53a of the casing part 50 to the outside. The cross-sectional shape of the hole portion 55a is the shape corresponding to the outer circumference of the tube 62, for example, a circle. The inner circumferential surface of the hole portion 55a is desirably in tight contact with the outer circumferential surface of the tube 62.

As described in the first embodiment, the wall portions 51 and 52 and the bottom portion 53 constitute the casing part 50. The lead wires 61 drawn out of the outlet portion 45 are housed in the housing space enclosed by the casing part 50 and the outer circumferential surface 35a of the mold resin part 35.

The tube enclosing part 55 has a smaller dimension than the casing part 50 in at least one, more desirably both, of the circumferential direction and the axial direction. With this configuration, the cover member 5A can be reduced in size as a whole.

The tube enclosing part 55 has a prismatic shape in FIGS. 9 to 11, but may have other shapes, for example, a cylindrical shape. That is, the tube enclosing part 55 only needs to have the hole portion 55a through which the tube 62 is inserted.

The motor of the second embodiment is configured in the same manner as the motor 1 of the first embodiment except for the points described above.

As described above, in the second embodiment, the cover member 5A has the tube enclosing part 55 covering the tube 62. Thus, water is less likely to enter the cover member 5A, and as a result, the entry of water into the motor 1 can be suppressed effectively.

### Third Embodiment

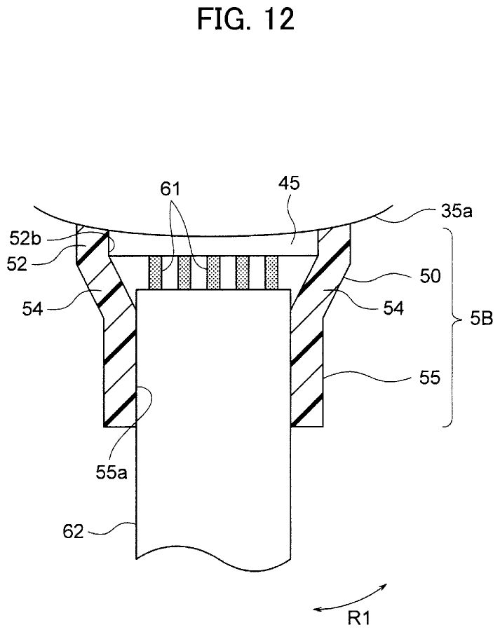

Next, a third embodiment will be described. FIG. 12 is a sectional view in a plane orthogonal to the center axis Ax, illustrating a cover member 5B, the outlet portion 45, and the lead wires 61 of the third embodiment. The cover member 5B has a tapered portion 54 on the tube enclosing part 55 side of the casing part 50.

Specifically, in the pair of second wall portions 52 of the casing part 50, the tapered portions 54 are formed at the tube enclosing part 55 side with respect to the outlet portion 45. The tapered portions 54 in the pair of second wall portions 52 are inclined so that an interval between the tapered portions 54 is wider on the outlet portion 45 side and is narrower on the tube enclosing part 55 side.

FIG. 12 illustrates the tapered portions 54 at the second wall portions 52. However, the tapered portion 54 may be provided at the first wall portion 51. The tapered portion 54 may be provided at both of the first and second wall portions 51 and 52.

The motor of the third embodiment is configured in the same manner as the motor 1 of the second embodiment except for the above-described points.

As described above, in the third embodiment, since the cover member 5B has the tapered portions 54, the amount of resin forming the cover member 5B can be reduced, and thus the manufacturing cost can be reduced, in addition to the effects described in the second embodiment.

### Fourth Embodiment

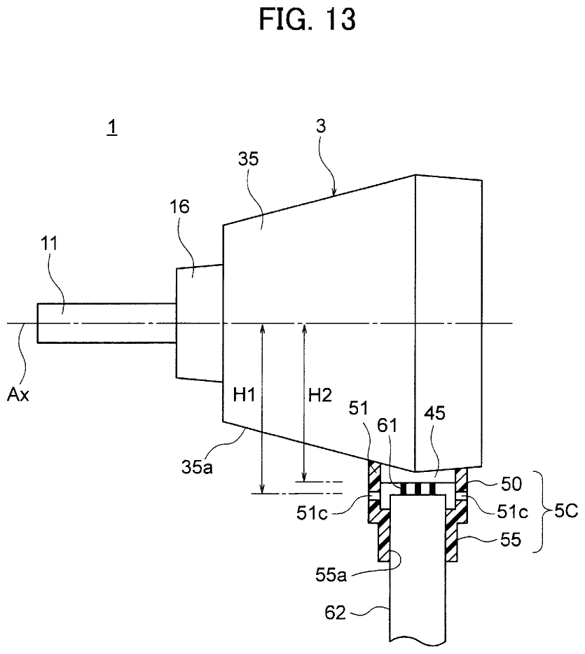

Next, a fourth embodiment will be described. FIG. 13 is a side view of the motor 1 of the fourth embodiment, illustrating a cover member 5C cut out in a plane parallel to the center axis Ax. The cover member 5C of the fourth embodiment has through holes 51c in the first wall portions 51.

Each through hole 51c is an outlet through which water is discharged to the outside of the cover member 5C when the water is stored in the cover member 5C. The size of the through hole 51c only needs to be a size at which the through hole 51c allows water to pass therethrough.

The shortest distance H1 from the center axis Ax to the through hole 51c is longer than the longest distance H2 from the center axis Ax to the outlet portion 45. That is, the through hole 51c of the cover member 5C is located at a lower level than the outlet portion 45 in the state where the motor 1 is mounted on the mounting portion.

With this configuration, when water is stored in the cover member 5C, the water can be discharged through the through holes 51c before it reaches the height of the outlet portion 45. As a result, the entry of water into the motor 1 can be suppressed effectively.

The through hole 51c extends in parallel to the center axis Ax. That is, the through hole 51c extends horizontally in the state where the motor 1 is mounted on the mounting portion. Thus, water vapor rising from below the motor 1 can be prevented from entering the cover member 5C through the through holes 51c.

In FIG. 13, the through holes 51c are formed on both of the pair of first wall portions 51. However, the through hole 51c may be formed on only one of the first wall portions 51. The through hole may be formed on the second wall portion 52 instead of the first wall portion 51. That is, it is sufficient that a through hole for discharging water is formed in at least one portion in the casing part 50.

The cover member 5C illustrated in FIG. 13 has the tube enclosing part 55 described in the second embodiment, but may be configured to have no tube enclosing part 55. The cover member 5C may have the tapered portion 54 described in the third embodiment.

The motor of the fourth embodiment is configured in the same manner as the motor 1 of the first embodiment except for the above-described points.

As described above, in the fourth embodiment, since the cover member 5C has the through hole 51c in at least one portion in the casing part 50, water can be discharged through the through hole 51c when the water is stored in the cover member 5C. Thus, the entry of water into the motor 1 can be effectively suppressed.

In particular, since the through hole 51c of the cover member 5C is located at a lower level than the outlet portion 45 in the state where the motor 1 is mounted on the mounting portion, the water in the cover member 5C can be discharged through the through holes 51c before the water reaches the height of the outlet portion 45. Thus, the entry of water into the motor 1 can be effectively suppressed.

### Fifth Embodiment

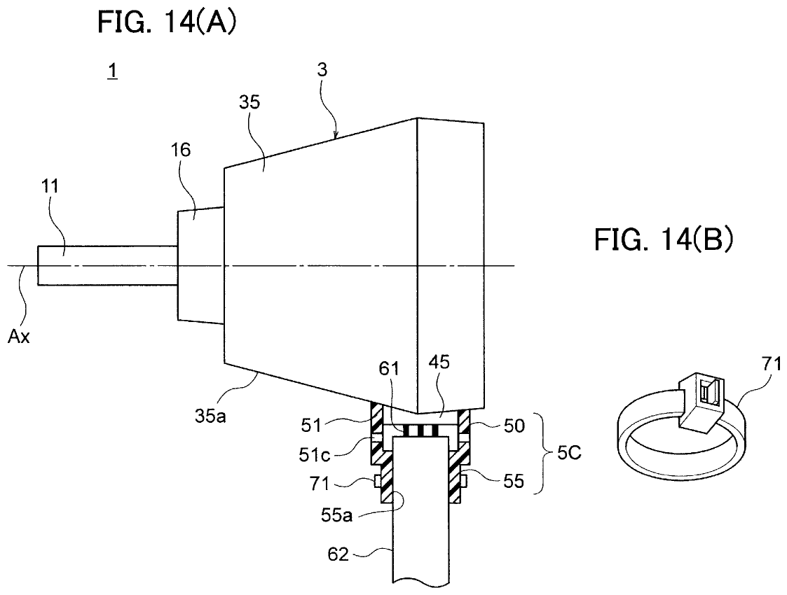

Next, a fifth embodiment will be described. FIG. 14(A) is a side view of a motor 1 of the fifth embodiment, illustrating a cover member 5C and a fastening member 71 which are cut out in a plane parallel to the center axis Ax. In the fifth embodiment, the fastening member 71 is provided to enclose the tube enclosing part 55 of the cover member 5C.

FIG. 14(B) is a perspective view illustrating the fastening member 71. The fastening member 71 is a bundling band formed of a resin. More specifically, the fastening member 71 is INSULOK (registered trademark) formed of nylon. The fastening member 71 is able to fasten the tube enclosing part 55, the tube 62 inside the tube enclosing part 55, and the lead wires 61 inside the tube 62 at one time.

The tube enclosing part 55 and the tube 62 tightly contact each other, and suppress the entry of water through the gap therebetween into the cover member 5C. Thus, the entry of water into the motor 1 can be suppressed.

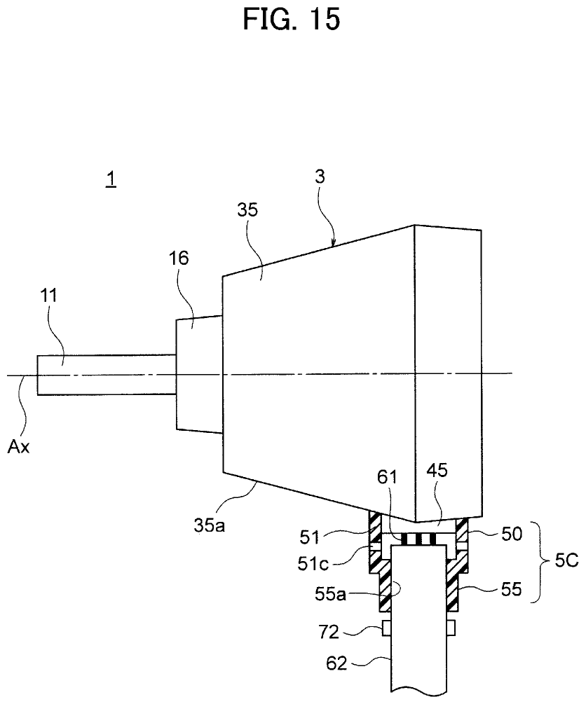

FIG. 15 is a diagram illustrating another configuration example of the fifth embodiment. In the configuration example illustrated in FIG. 15, a fastening member 72 is provided under the cover member 5C, i.e., on the side opposite to the mold resin part 35 with respect to the cover member 5C so as to enclose the tube 62. The fastening member 72 has the same structure as the fastening member 71 illustrated in FIG. 14(B).

In this configuration example, the fastening member 72 fastens the tube 62 and the lead wires 61 therein. Since the fastening member 72 is fixed to the tube 62, the cover member 5C can be positioned between the fastening member 72 and the mold resin part 35 in the drawing direction of the lead wires 61. The fastening force of the fastening member 72 may be smaller than that of the fastening member 71 illustrated in FIG. 14(A).

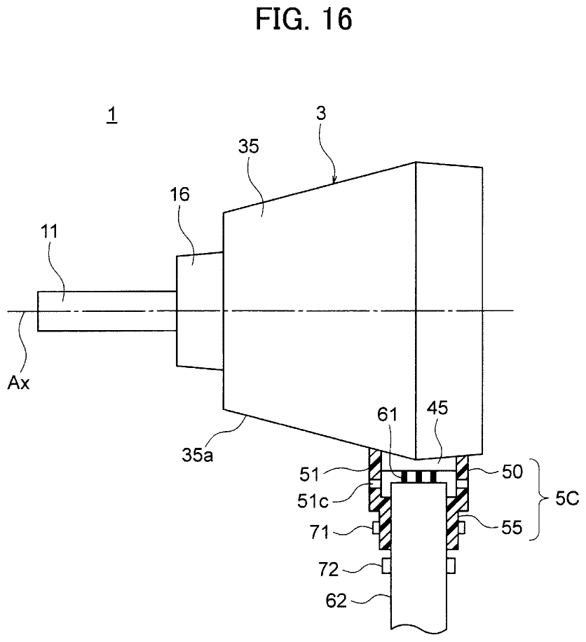

FIG. 16 is a diagram illustrating still another configuration example of the fifth embodiment. In the configuration example illustrated in FIG. 16, the fastening member 71 is provided to enclose the tube enclosing part 55, while the fastening member 72 is provided to enclose the tube 62. The structures of the fastening members 71 and 72 are as described above.

In this configuration example, the tube enclosing part 55, the tube 62, and the lead wires 61 are fastened by the fastening member 71, while the tube 62 and the lead wires 61 are fastened by the fastening member 72. The fastening member 71 suppresses the entry of water through the gap between the tube enclosing part 55 and the tube 62 into the cover member 5C. Furthermore, the fastening member 72 can position the cover member 5C in the drawing direction of the lead wires 61.

In FIGS. 14(A) to 16, the cover member 5C described in the fourth embodiment is shown, but either the cover member 5A or 5B described in the second or third embodiment may be used instead of the cover member 5C.

The motor of the fifth embodiment is configured in the same manner as the motor 1 of the first embodiment except for the points described above.

As described above, in the fifth embodiment, the entry of water through the gap between the tube enclosing part 55 and the tube 62 into the cover member 5C can be suppressed by providing the fastening member 71 enclosing the tube enclosing part 55. Furthermore, the cover member 5C can be positioned in the drawing direction of the lead wires 61 by providing the fastening member 72 enclosing the tube 62 on the side opposite to the mold resin part 35 with respect to the cover member 5C.

### Sixth Embodiment

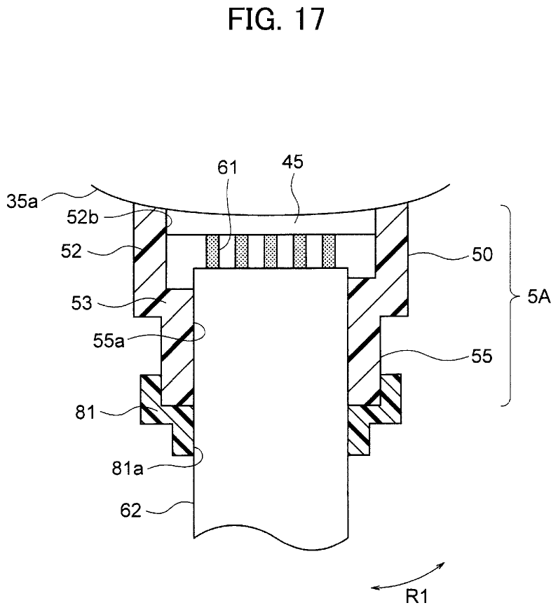

Next, a sixth embodiment will be described. FIG. 17 is a sectional view in a plane orthogonal to the center axis Ax, illustrating the cover member 5A, a pipe-shaped member 81, the outlet portion 45, and the lead wires 61 of the sixth embodiment. In the sixth embodiment, the pipe-shaped member 81 is provided to cover the tube enclosing part 55 of the cover member 5A and the tube 62.

The pipe-shaped member 81 is formed of a heat-shrinkable resin. The heat-shrinkable resin is, for example, fluorine resin, polyvinyl chloride, silicone rubber, or polyolefin. The pipe-shaped member 81 covers the tube enclosing part 55 of the cover member 5A and also covers the tube 62 drawn out of the tube enclosing part 55.

The pipe-shaped member 81 is shrunk by applying heat thereto in a state where the pipe-shaped member 81 covers the tube enclosing part 55 and the tube 62. Thus, a portion of the tube 62 exposed from the tube enclosing part 55 is covered with the pipe-shaped member 81.

Since the tube enclosing part 55 and the tube 62 are covered with the pipe-shaped member 81, the tube enclosing part 55 and the tube 62 are brought into tight contact with each other. Thus, it is possible to suppress the entry of water through the gap between the tube enclosing part 55 and the tube 62 into the cover member 5A. Furthermore, since the tube enclosing part 55 is fastened with the pipe-shaped member 81, the cover member 5A can be positioned in the drawing direction of the lead wires 61.

In FIG. 17, the cover member 5A described in the second embodiment is shown, but either the cover member 5B or 5C described in the third or fourth embodiment may be used instead of the cover member 5A. The fastening member 71 or 72 described in the fifth embodiment may be added.

The motor of the sixth embodiment is configured in the same manner as the motor 1 of the first embodiment except for the points described above.

As described above, in the sixth embodiment, the pipe-shaped member 81 covers the tube enclosing part 55 and the tube 62, and thus the entry of water through the gap between the tube enclosing part 55 and the tube 62 into the cover member 5A can be suppressed. Therefore, the entry of water into the motor 1 can be effectively suppressed.

### Seventh Embodiment

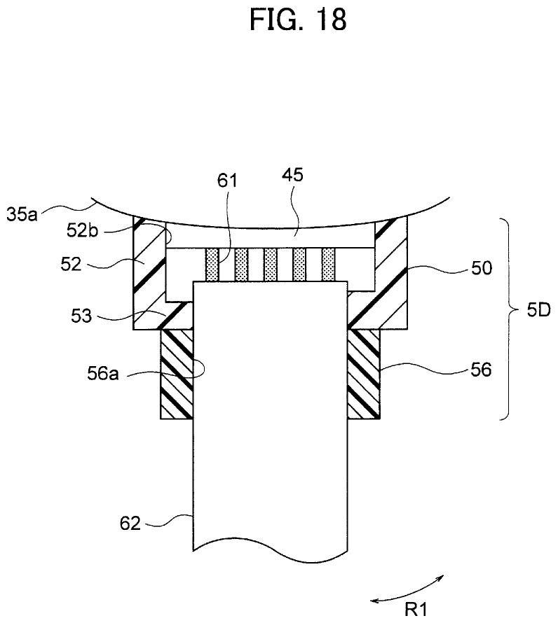

Next, a seventh embodiment will be described. FIG. 18 is a sectional view in a plane orthogonal to the center axis Ax, illustrating a cover member 5D, the outlet portion 45, and the lead wires 61 of the seventh embodiment. In the cover member 5A of the second embodiment described above, the casing part 50 and the tube enclosing part 55 are integrally formed of the same material. In contrast, in the cover member 5D of the seventh embodiment, the casing part 50 and a tube enclosing part 56 are formed of different materials.

The tube enclosing part 56 of the seventh embodiment is formed of a heat-shrinkable resin. The heat-shrinkable resin is, for example, fluorine resin, polyvinyl chloride, silicone rubber, or polyolefin. The tube enclosing part 56 has a hole portion 56a through which the tube 62 passes. The cross-sectional shape of the hole portion 56a is the shape corresponding to the outer circumference of the tube 62, for example, a circle.

The tube enclosing part 56 and the tube 62 can be brought into tight contact with each other by inserting the tube 62 through the hole portion 56a of the tube enclosing part 56 and then applying heat to the tube enclosing part 56 so that the tube enclosing part 56 shrinks.

The tube enclosing part 56 and the tube 62 are brought into tight contact with each other, and thus it is possible to suppress the entry of water through the gap between the tube enclosing part 56 and the tube 62 into the cover member 5D. Since the tube enclosing part 56 is pressed into contact with the tube 62, the cover member 5D can be positioned in the drawing direction of the lead wires 61.

The cover member 5D of FIG. 18 may be provided with the tapered portion 54 described in the third embodiment, or may be provided with the through hole 51c described in the fourth embodiment. The fastening members 71 and 72 described in the fifth embodiment, or the pipe-shaped member 81 described in the sixth embodiment may be added.

The motor of the seventh embodiment is configured in the same manner as the motor 1 of the first embodiment except for the above-described points.

As described above, in the seventh embodiment, the tube enclosing part 56 of the cover member 5D is formed of a heat-shrinkable rubber, so that the tube enclosing part 56 can be brought into tight contact with the tube 62, and thus it is possible to suppress the entry of water through the gap therebetween into the cover member 5D. Thus, the entry of water into the motor 1 can be effectively suppressed.

### Eighth Embodiment

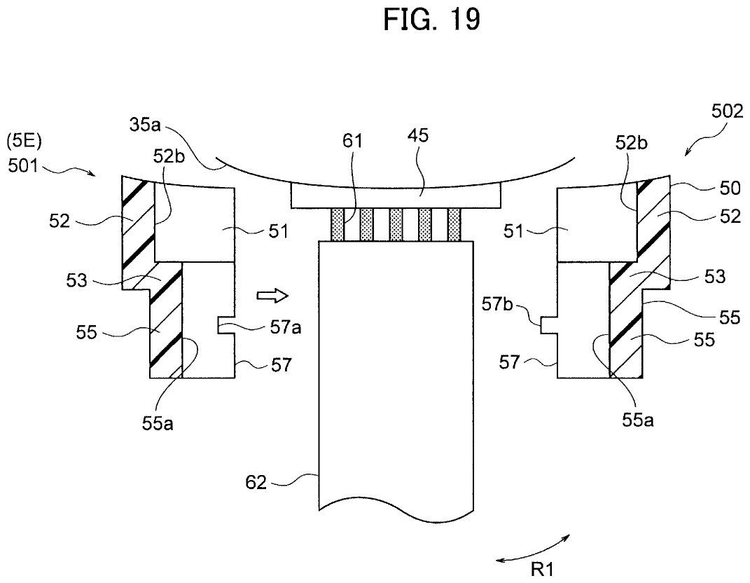

Next, an eighth embodiment will be described. FIG. 19 is a sectional view illustrating a state in which a cover member 5E of the eighth embodiment is divided, together with the outlet portion 45 and the lead wires 61. The cover member 5E of the eighth embodiment is divided into two constituent parts 501 and 502 at division surfaces 57.

The division surface 57 is a surface that is parallel to the drawing direction of the lead wires 61 and passes through the housing space inside the casing part 50 and the hole portion 55a of the tube enclosing part 55. The division surface 57 desirably passes through the center of the housing space inside the casing part 50 and the center of the hole portion 55a of the tube enclosing part 55.

The division surface 57 of the constituent part 501 is provided with a concave portion 57a. The division surface 57 of the constituent part 502 is provided with a convex portion 57b that is fitted into the concave portion 57a of the constituent part 501.

The convex portion 57b is fitted into the concave portion 57a in a state where the division surfaces 57 of the constituent parts 501 and 502 are in tight contact with each other, and thus the constituent parts 501 and 502 are fixed to each other. The concave portion 57a and the convex portion 57b are formed in the tube enclosing part 55 in FIG. 19, but they may be formed in the casing part 50 or in both the tube enclosing part 55 and the casing part 50.

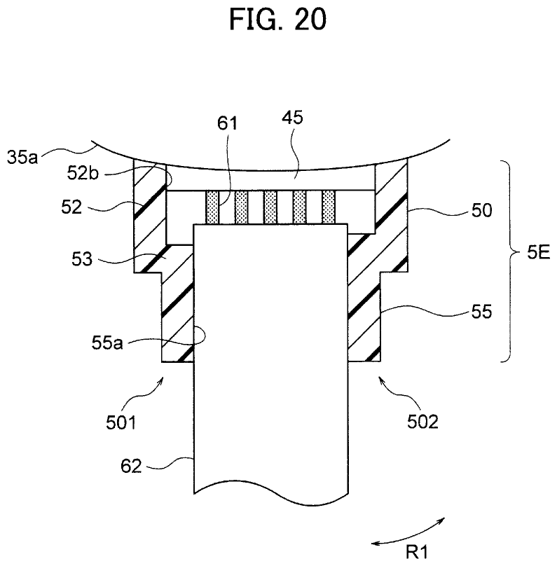

FIG. 20 is a sectional view illustrating the cover member 5E configured by a combination of the constituent parts 501 and 502, together with the outlet portion 45 and the lead wires 61. The constituent parts 501 and 502 are combined so as to sandwich the lead wires 61 and the tube 62 therebetween. The cover member 5E is obtained by combining the constituent parts 501 and 502 at the division surfaces 57.

By assembling the cover member 5E, the lead wires 61 are housed in the casing part 50, so that the outer circumferential surface of the tube 62 comes into contact with the inner circumferential surface of the hole portion 55a of the tube enclosing part 55. The inner surfaces 51b and 52b of the casing part 50 are fitted to the outlet portion 45.

The casing part 50 and the tube enclosing part 55 are configured in the same manner as the casing part 50 and the tube enclosing part 55 described in the second embodiment except that each of the casing part 50 and the tube enclosing part 55 is divided at the division surface 57.

The cover member 5E is formed by assembling the constituent parts 501 and 502, and thus the cover member 5E can be easily attached to the portion through which the lead wires 61 are drawn out. In this example, the cover member 5E is divided into two pieces in the circumferential direction about the center axis Ax, but the cover member 5E may be divided into two pieces in the direction of the center axis Ax, i.e., in the axial direction. The cover member 5E may be configured by combining three or more constituent parts.

The cover member 5E may be provided with the tapered portion 54 described in the third embodiment or may be provided with the through hole 51c described in the fourth embodiment. The fastening members 71 and 72 described in the fifth embodiment, the pipe-shaped member 81 described in the sixth embodiment, or the tube enclosing part 56 of the seventh embodiment may be provided. The cover member 5 of the first embodiment may be configured by combining a plurality of constituent parts.

The motor of the eighth embodiment is configured in the same manner as the motor 1 of the first embodiment except for the above-described points.

As described above, in the eighth embodiment, the cover member 5E can be formed by combining the constituent parts 501 and 502, and thus the cover member 5E can be simply attached to the mold resin part 35.

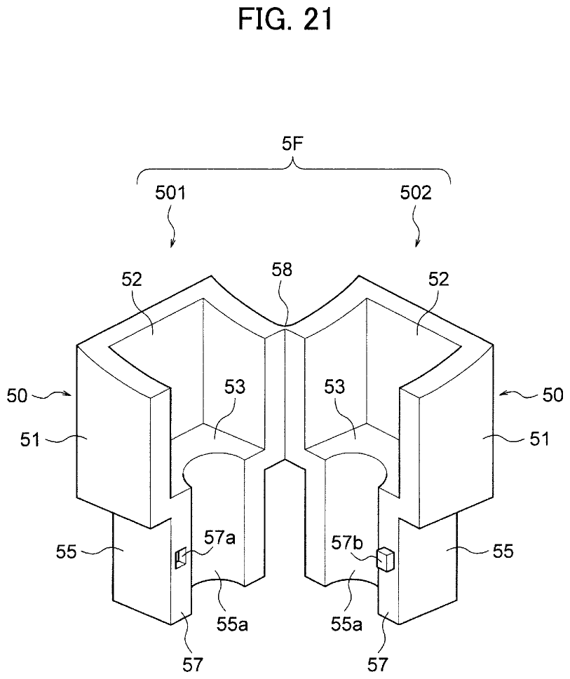

FIG. 21 is a perspective view illustrating a state in which a cover member 5F of a modification of the eighth embodiment is divided. The cover member 5F is divided into two constituent parts 501 and 502 at division surfaces 57, and the constituent parts 501 and 502 are coupled to each other via a coupling portion 58 that is deformable.

In this example, the coupling portion 58 is an elastically deformable thin-walled portion formed between the constituent parts 501 and 502. The coupling portion 58 extends in parallel to the drawing direction of the lead wires 61 along one side of the division surface 57 in the casing part 50. The coupling portion 58 is not limited to the thin-walled portion, but may be a hinge, for example.

The constituent parts 501 and 502 are combined so as to sandwich the lead wires 61 and the tube 62 therebetween while deforming the coupling portion 58. The cover member 5F is obtained by combining the constituent parts 501 and 502 at the division surfaces 57.

In this modification, the constituent parts 501 and 502 of the cover member 5F are coupled by the coupling portion 58, and thus the cover member 5F can be handled as a single part when it is attached to the mold resin part 35. Thus, the cover member 5F can be more easily attached to the mold resin part 35.

### (Air Conditioner)

Next, the air conditioner 100 to which the motor of each of the embodiments and modifications is applicable will be described. FIG. 22(A) illustrates the configuration of the air conditioner 100. The air conditioner 100 includes an outdoor unit 101, an indoor unit 102, and a refrigerant pipe 103 that connects these units.

The outdoor unit 101 includes an outdoor fan 110 which is, for example, a propeller fan. The indoor unit 102 includes an indoor fan 120 which is, for example, a cross flow fan. The outdoor fan 110 includes an impeller 105 and the motor 1 driving the impeller 105. The indoor fan 120 includes an impeller 121 and the motor 1 that drives the impeller 121. FIG. 22(A) also illustrates a compressor 104 that compresses refrigerant.

FIG. 22(B) is a sectional view of the outdoor unit 101. The motor 1 is supported by the frame 109 disposed in a housing 108 of the outdoor unit 101. The impeller 105 is attached to the shaft 11 of the motor 1 via a hub 106.

In the outdoor fan 110, the rotation of the motor 1 causes the impeller 105 to rotate to blow air to the outside of a room. During a cooling operation of the air conditioner 100, heat is released when the refrigerant compressed in the compressor 104 is condensed in a condenser, and the heat is released to the outside of the room by air blown by the outdoor fan 110.

Similarly, in the indoor fan 120 (FIG. 22(A)), the rotation of the motor 1 causes the impeller 121 to rotate to blow air to the inside of the room. During the cooling operation of the air conditioner 100, air is deprived of heat as the refrigerant evaporates in an evaporator, and the air is blown into the room by the indoor fan 120.

The motor 1 of each embodiment and modification described above has improved operational stability because of suppression of the entry of water. Thus, by using the motor 1 as the driving source of each of the fans 110 and 120 of the air conditioner 100, it is possible to improve the reliability of the air conditioner 100.

Although the motor 1 is used as the driving source for the outdoor fan 110 and also as the driving source for the indoor fan 120 in this example, it is sufficient that the motor 1 is used as at least one of these driving sources.

In addition, the motor 1 described in each embodiment and modification can also be installed on electric apparatuses other than the fan of the air conditioner.

Although the desirable embodiments have been specifically described, the present disclosure is not limited to the above embodiments, and various modifications and changes can be made to those embodiments.

1. A motor comprising:
a rotor;
a stator surrounding the rotor;
a circuit board attached to the stator;
a mold resin part covering the stator and the circuit board;
a lead wire connected to the circuit board and drawn out of the mold resin part; and
a cover member provided on the mold resin part and made of a resin,
wherein the cover member and an outer circumferential surface of the mold resin part form a housing space in which the lead wire is housed, the cover member having a hole portion through which the lead wire is drawn out of the housing space,
wherein the cover member has a curved surface facing the mold resin part, and
wherein a curvature radius r of the curved surface is smaller than or equal to a curvature radius R of the outer circumferential surface of the mold resin part.

2. The motor according to claim 1, wherein a modulus of elasticity of a resin forming the cover member is lower than a modulus of elasticity of a resin forming the mold resin part.

3. (canceled)

4. The motor according to claim 1, wherein the cover member is disposed inside both end surfaces of the mold resin part in a direction of a rotary shaft of the rotor.

5. The motor according to claim 1, wherein the lead wire is drawn out of the mold resin part downward in a state where the motor is mounted on a mounting portion.

6. The motor according to claim 1, wherein the mold resin part is provided with an outlet portion through which the lead wire is drawn out, and
wherein the cover member is fitted to the outlet portion.

7. The motor according to claim 1, wherein the cover member is provided with a through hole that connects the housing space and an outside of the cover member.

8. The motor according to claim 7, wherein the through hole is located under a portion through which the lead wire is drawn out of the mold resin part, in a state where the motor is mounted on a mounting portion.

9. The motor according to claim 7, wherein the through hole extends horizontally in a state where the motor is mounted on the mounting portion.

10. The motor according to claim 1, wherein the cover member further comprises a tube enclosing part that encloses a tube covering the lead wire drawn out of the hole portion.

11. The motor according to claim 10, wherein the cover member has a casing part that forms the housing space between the outer circumferential surface of the mold resin part and the casing part, and
wherein the tube enclosing part has a smaller dimension than the casing part in at least one of a direction of a rotation axis of the rotor and a circumferential direction about the rotation axis.

12. The motor according to claim 11, wherein a tapered portion is formed on the tube enclosing part side of the casing part.

13. The motor according to claim 10, further comprising:
a fastening member fastening the tube enclosing part, the tube inside the tube enclosing part, and the lead wire inside the tube.

14. The motor according to claim 10, further comprising:
a fastening member disposed on a side opposite to the mold resin part with respect to the cover member, the fastening member fastening the tube and the lead wire inside the tube.

15. The motor according to claim 10, further comprising:
a first fastening member fastening the tube enclosing part, the tube inside the tube enclosing part, and the lead wire inside the tube; and
a second fastening member disposed on a side opposite to the mold resin part with respect to the cover member, the second fastening member fastening the tube and the lead wire inside the tube.

16. The motor according to claim 10, further comprising:
a pipe-shaped member made of a resin and covering the tube enclosing part and the tube extending to outside from the tube enclosing part.

17. The motor according to claim 16, wherein the pipe-shaped member is formed of a heat-shrinkable resin.

18. The motor according to claim 10, wherein the tube enclosing part is formed of a heat-shrinkable resin.

19. The motor according to claim 1, wherein the cover member is formed of a combination of a plurality of constituent parts.

20. The motor according to claim 19, wherein the plurality of constituent parts of the cover member is coupled together by a coupling portion.

21. A fan comprising:
the motor according to claim 1; and
an impeller rotated by the motor.

22. An air conditioner comprising an indoor unit, an outdoor unit, and a refrigeration pipe connecting the indoor unit and the outdoor unit,
wherein at least one of the indoor unit and the outdoor unit comprises the fan according to claim 21.
